(19) United States
(12) Patent Application Publication
(10) Pub. No.: US 2006/0003762 A1
(43) Pub. Date: Jan. 5, 2006

(54) Method and system for telematically deactivating satellite radio systems

(75) Inventors: Anthony J. Sumcad, Southfield, MI (US); Russell A. Patenaude, Macomb Township, MI (US); Hitan S. Kamdar, Utica, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/875,001

(22) Filed: Jun. 22, 2004

(51) Int. Cl. H04Q 7/20

(52) U.S. Cl. 455/428; 455/13.1

(57) ABSTRACT

A method for confirming deactivation of a mobile vehicle satellite radio service includes receiving a satellite radio termination signal at a call center, sending a termination notification from the call center to a telematics unit via a wireless interface responsive to the termination signal and sending a termination confirmation from the telematics unit to the call center responsive to the termination notification.

### FIELD OF THE INVENTION

This invention relates generally to a telematics and satellite digital audio radio systems in a vehicle. In particular, the invention relates to a method, computer usable medium and system for deactivating and reactivating a satellite radio system in vehicles equipped with a telematics system and a satellite digital audio radio system.

### BACKGROUND OF THE INVENTION

The opportunity to personalize features in a mobile vehicle is ever increasing as the automobile is being transformed into a communications and entertainment platform as well as a transportation platform. Many new vehicles will be installed with some type of telematics unit to provide wireless communication and location-based services. These services may be accessed through interfaces such as voice-recognition computer applications, touch-screen computer displays, computer keyboards, or a series of buttons on the dashboard or console of a vehicle.

Currently, telematics service call centers, in-vehicle compact disk (CD) or digital video display (DVD) media, web portals, and voice-enabled phone portals provide various types of location services, including driving directions, stolen vehicle tracking, traffic information, weather reports, restaurant guides, ski reports, road condition information, accident updates, street routing, landmark guides, and business finders.

For example, traffic and driving directions are accessible through a voice portal that uses incoming number identification to generate location information based on the area code or prefix of the phone number, or to access location information stored in a user's profile associated with the phone number. In some embodiments, users are prompted to enter more details through a voice interface. Other examples are web and wireless portals that offer location-based services such as maps and driving directions where the user enters both a start and end addresses. Some of these services have a voice interface.

Some telematics service users elect to establish a mobile vehicle satellite radio service account, such as Satellite Digital Audio Radio Service (SDARS), as well as a telematics system account. The SDARS system provides continuous radio broadcast reception for vehicles across locations which otherwise would be discontinuous across geographic regions.

Currently when a SDARS account expires or is cancelled the satellite deactivation server within the mobile vehicle satellite radio service system triggers the satellite to broadcast a periodic deactivation signal.

If the SDARS satellite radio receiver is powered ON, the deactivation signal is received and hardware within the satellite radio receiver is modified to prevent it from receiving any signal other than the preview channel signal over the SDARS system. The former SDARS subscriber is potentially unaware that their SDARS account is deactivated. This may cause an increase in customer complaints at the SDARS call center, as a user can be confused by being unable to receive radio signals. The user may then communicate with the call center of the telematics system to complain that they are not able to receive all radio signals. An advisor in the SDARS call center is unaware of the deactivation of the SDARS account and is required to initiate communication with the deactivation server of the SDARS system to confirm deactivation of service for the former SDARS subscriber. Once the deactivation server confirms that the SDARS is deactivated, the advisor informs the user. This confirmation call takes time for the user and the call center

The SDARS satellite will continue to transmit the deactivation signal for the few days, even after the satellite radio receiver is modified to prevent it from receiving all radio signals, since the SDARS system does not know if and/or when the deactivation signal was implemented. This periodic broadcast wastes bandwidth for the telematics unit and the satellite.

If the SDARS satellite radio receiver is not powered ON, the deactivation signal is not received and the hardware within the satellite radio receiver is not modified to prevent it from receiving all transmitted signals. The SDARS deactivation server is unaware that the satellite radio receiver is not deactivated and a subscriber with an expired account may continue to use the satellite radio receiver until the SDARS system receives a deactivation signal.

It is desirable to provide a method, computer usable medium and system to overcome the limitations described above. It is desirable that a user of a telematics system be informed when their SDARS account is deactivated and that the call center receive confirmation that the SDARS user was notified when the SDARS account was deactivated in order to prevent confusion and a waste of system bandwidth and to provide a renewal option.

### SUMMARY OF THE INVENTION

One aspect of the present invention provides a method for confirming deactivation of a mobile vehicle satellite radio service. The method includes receiving a satellite radio termination signal at a call center, sending a termination notification from the call center to a telematics unit via a wireless interface responsive to the termination signal and sending a termination confirmation from the telematics unit to the call center responsive to the termination notification.

A second aspect of the invention provides a system to confirm deactivation of a mobile vehicle satellite radio service. The system includes means for receiving a satellite radio termination signal at a call center, means for sending a termination notification from the call center to a telematics unit via a wireless interface responsive to the termination signal and means for sending a termination confirmation from the telematics unit to the call center responsive to the termination notification.

A third aspect of the invention provides a computer readable medium storing a computer program. The medium includes computer readable code for receiving a satellite radio termination signal at a call center, computer readable code for sending a termination notification from the call center to a telematics unit via a wireless interface responsive to the termination signal and computer readable code for sending a termination confirmation from the telematics unit to the call center responsive to the termination notification.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

Various embodiments of the present invention are illustrated by the accompanying figures, wherein:

FIG. 1 is a schematic diagram of a system for data transmission over a wireless communication system integrated with a satellite digital audio radio service (SDARS) system, in accordance with the present invention;

FIG. 2 illustrates a flowchart representative of one embodiment of a method to confirm deactivation of a mobile vehicle satellite radio service in accordance with the present invention;

FIG. 3 illustrates a flowchart representative of one embodiment of a method to activate a customer termination confirmation process in accordance with the present invention; and

FIG. 4 illustrates a flowchart representative of one embodiment of a method to renew a mobile vehicle satellite ratio service in accordance with the present invention.

### DETAILED DESCRIPTION OF THE PRESENTLY PREFERRED EMBODIMENTS

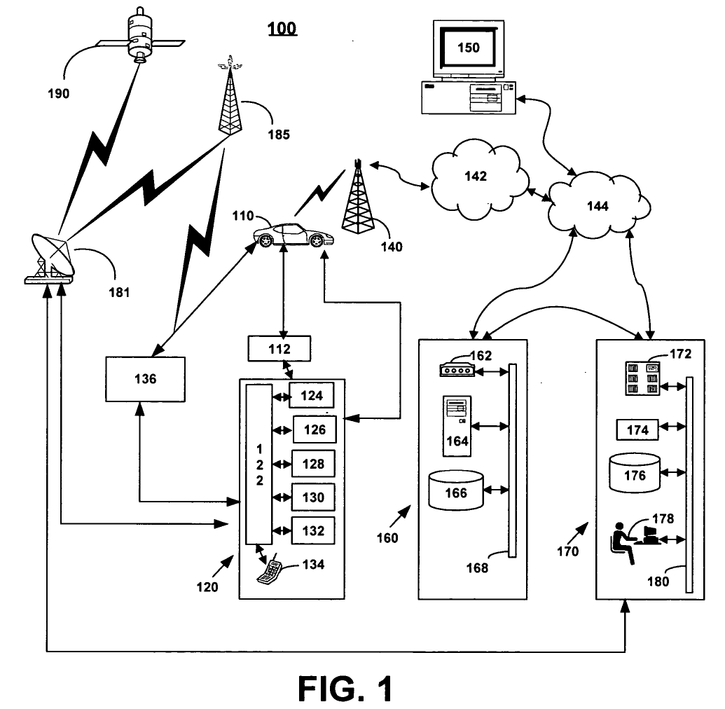

FIG. 1 is a schematic diagram of a system for data transmission over a wireless communication system integrated with a satellite digital audio radio service (SDARS) system, in accordance with the present invention. Mobile vehicle communication system (MVCS) 100 includes a mobile vehicle communication unit (MVCU) 110, a vehicle communication network 112, a telematics unit 120, a satellite radio receiver 136, one or more wireless carrier systems 140, one or more communication networks 142, one or more land networks 144, one or more satellite radio service uplink facilities 181, one or more terrestrial radio transmitters 185, one or more satellite radio service geostationary satellites 190, one or more client, personal or user computers 150, one or more web-hosting portals 160, and one or more call centers 170. In one embodiment, MVCU 110 is implemented as a mobile vehicle equipped with suitable hardware and software for transmitting and receiving voice and data communications. In one embodiment, MVCS 100 includes additional components not relevant to the present discussion. Mobile vehicle communication systems, telematics units and satellite digital audio radio services (SDARS) are known in the art.

MVCU 110 is also referred to as a mobile vehicle throughout the discussion below. In operation, MVCU 110 may be implemented as a motor vehicle, a marine vehicle, or as an aircraft. In one embodiment, MVCU 110 includes additional components not relevant to the present discussion.

MVCU 110, via a vehicle communication network 112, sends signals to various units of equipment and systems (detailed below) within MVCU 110 to perform various functions such as unlocking a door, opening the trunk, setting personal comfort settings, and calling from telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

MVCU 110, via telematics unit 120, sends and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (GPS) unit 126, an in-vehicle memory 128, a microphone 130, one or more speakers 132, and an embedded or in-vehicle mobile phone 134. In other embodiments, telematics unit 120 may be implemented without one or more of the above listed components, such as, for example GPS unit 126 or speakers 132. In some embodiments, telematics unit 120 includes additional components not relevant to the present discussion.

In one embodiment, processor 122 is a digital signal processor (DSP). In one embodiment, processor 122 is implemented as a microcontroller, microprocessor, controller, host processor, or vehicle communications processor. In an example, processor 122 is implemented as an application specific integrated circuit (ASIC). In another embodiment, processor 122 is implemented as a processor working in conjunction with a central processing unit (CPU) performing the function of a general purpose processor. GPS unit 126 provides longitude and latitude coordinates of the vehicle responsive to a GPS broadcast signal received from a one or more GPS satellite broadcast systems (not shown). In-vehicle mobile phone 134 is a cellular-type phone, such as, for example an analog, digital, dual-mode, dual-band, multi-mode or multi-band cellular phone.

Processor 122 executes various computer programs that control programming and operational modes of electronic and mechanical systems within MVCU 110. Processor 122 controls communications (e.g. call signals) between telematics unit 120, wireless carrier system 140, terrestrial radio transmitter 185 or a satellite radio geostationary satellite 190 and call center 170. In one embodiment, processor 122 can translate human voice input through microphone 130 to digital signals. In another embodiment, processor 122 includes voice-recognition software to parse the speech and/or identify the user. Software to parse speech and/or identify a use may also be resident at call center 170. Processor 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers. In this embodiment, signals from processor 122 are translated into voice messages and sent out through speaker 132. Processor 122 directs communications between in-vehicle mobile phone 134 and satellite radio receiver 136 as well as communications from the telematics unit 120 through in-vehicle mobile phone 134.

Satellite radio receiver 136 is any suitable hardware for receiving satellite radio broadcast signals in MVCU 110. Satellite radio receiver 136 receives digital signals from a terrestrial radio transmitter 185 or a satellite radio geostationary satellite 190. Satellite radio receiver 136 includes a radio receiver for receiving broadcast radio information over one or more channels. In one embodiment, satellite radio receiver 136 generates an audio output in response to received signals. In another embodiment, satellite radio receiver 136 receives data communications from the satellite service provider.

Satellite radio receiver 136 is separate from telematics unit 120 in one embodiment. In an alternative embodiment, satellite radio receiver 136 is electronically connected to telematics unit 120 with a cable or over the vehicle communication bus, or with a wireless communication protocol. In another embodiment, satellite radio receiver 136 is embedded within the telematics unit 120. Satellite radio receiver 136 provides channel and signal information to telematics unit 120. Telematics unit 120 monitors, filters and sends signals that are received from satellite broadcast, radio broadcasts or other wireless communication systems to output devices such as speaker 132 and visual display devices. In one embodiment, signals from satellite radio receiver 136 are sent directly to in-vehicle mobile phone 134 without the intervening telematics unit 120.

In one embodiment, in-vehicle mobile phone 134 is integral with telematics unit 120 and coupled electronically with satellite radio receiver 136. In an alternative embodiment, in-vehicle mobile phone 134 is separated from telematics unit 120 and coupled electronically to telematics unit 120 as well as satellite radio receiver 136.

As part of a satellite broadcast system, a satellite radio uplink facility 181 sends and receives radio signals to a geostationary satellite 190. Satellite radio uplink facility 181 uplinks information necessary to initiate in-vehicle wireless communications from the SDARS call center to one or more terrestrial radio transmitters 185. In one embodiment, satellite radio uplink facility 181 also sends information necessary to initiate in-vehicle wireless communications to geostationary satellite 190.

Terrestrial radio transmitter 185 and geostationary satellite 190 transmit radio signals to satellite radio receiver 136 in MVCU 110. In one embodiment, terrestrial radio transmitter 185 and geostationary satellite 190 broadcast over a spectrum in the S band (2.3 GHz) that has been allocated by the U.S. Federal Communications Commission (FCC) for nationwide broadcasting of Satellite Based Digital Radio Service (SDARS). An exemplary broadcast has a 120 kilobyte per second portion of the bandwidth designated for command signals from telematics service call center 170.

In addition to broadcasting music and entertainment, traffic information, road construction information, advertisements, news and information on local events, the satellite radio broadcast system can send a Mobile Identification Number (MIN), satellite radio subscriber identifier and wireless communication parameters to satellite radio receiver 136 to initiate an in-vehicle mobile phone 134 to call telematics service call center 170.

Telematics unit 120 monitors satellite radio system broadcast signals received by satellite radio receiver 136 for a signal with this information on wireless communication initiation. When such a signal is detected, the satellite radio identifier and associated information are extracted from the broadcast channel. Telematics unit 120 stores or retrieves data and information from the audio signals of satellite radio receiver 136.

In one embodiment, the signal includes a satellite radio subscriber identifier, which identifies the unique number assigned by the manufacturer of the satellite radio receiver 136, a MIN that has been assigned to the in-vehicle mobile phone 134, wireless communication parameters, or any combination thereof. The parameters comprise a home system identifier, a mobile identification number, a call number, a preferred roaming list, a preferred roaming list flag, a configuration flag, a configuration parameter or a combination thereof.

The signal from the satellite radio system could include a request for the telematics unit 120 to call the telematics call center 170. In response, telematics unit 120 places a call with in-vehicle mobile phone 134 via a wireless telephony service provider.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal or user computer 150 includes a computer usable medium to execute Internet browser and Internet-access computer programs for sending and receiving data over land network 144 and optionally, wired or wireless communication networks 142 to web-hosting portal 160. Personal or client computer 150 sends user preferences to web-hosting portal through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110. In operation, a client utilizes computer 150 to initiate setting or re-setting of user-preferences for MVCU 110. User-preference data from client-side software is transmitted to server-side software of web-hosting portal 160. User-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and from modem 162, data that is then transferred to web server 164. In one embodiment, modem 162 resides inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations and theft alarm settings. For each client, the web server potentially stores hundreds of preferences for wireless vehicle communication, networking, maintenance and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center 170 is a telematics call center, facilitating communications to and from telematics unit 120 in MVCU 110. In an example, the call center 170 is a voice call center, providing verbal communications between an advisor in the call center and a subscriber in a mobile vehicle. In another example, the call center 170 contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services, including enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160 and land network 144. Communication services manager 174 transmits user-preference and other data to telematics unit 120 in MVCU 110 through wireless carrier system 140, communication network 142, land network 144, voice and data switch 172, and network system 180. Communication services manager 174 stores or retrieves data and information from communication services database 176. In some embodiments, communication services manager 174 is operable to provide requested information to communication services advisor 178.

In one embodiment, communication services advisor 178 is implemented as a real advisor. In an example, a real advisor is a human being in verbal communication with a user or subscriber (e.g. a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicate with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

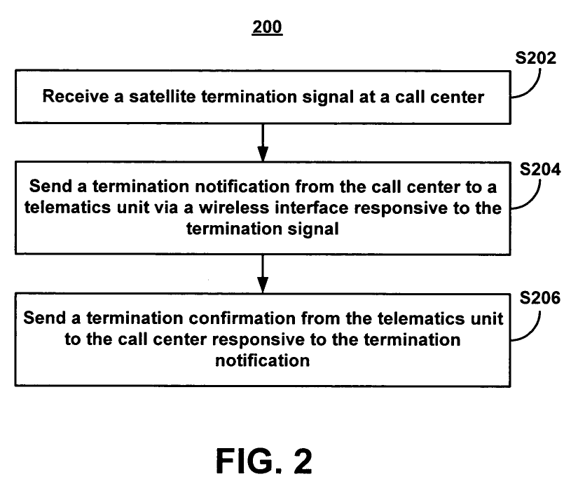

FIG. 2 illustrates a flowchart representative of one embodiment of a method to confirm deactivation of a mobile vehicle satellite radio service in accordance with the present invention. The following discussion of flowchart 200 is related to exemplary mobile vehicle communication system (MVCS) 100 as shown in FIG. 1.

During stage S202, the communication service manager 174 in call center 170 receives a satellite termination signal. A deactivation server of a mobile vehicle satellite radio system sends the satellite radio termination signal to the call center 170 responsive to a deactivation command being transmitted from the deactivation server to a satellite radio receiver 136 of a telematics equipped vehicle 110.

In one embodiment, the deactivation command and the resulting termination signal are transmitted when a SDARS account expires or alternatively, when a SDARS subscriber cancels an account. The account expires after the account duration has elapsed or after an account payment is delinquent. In another embodiment, the termination signal is sent upon changes to the SDARS service, or for any other reason that may be appropriate to terminate SDARS service.

The deactivation server sends the deactivation command over the satellite radio service network, which comprises the radio service uplink facilities 181, one or more terrestrial radio transmitters 185, one or more satellite radio service geostationary satellites 190 to the satellite radio receiver 136. In one embodiment, the deactivation server transmits the satellite termination signal over one or more wireless carrier systems 140, one or more communication networks 142 or one or more land networks 144 to the call center 170. In another embodiment, the deactivation server transmits the satellite termination signal from the satellite radio service uplink facility 181 to the call center 170.

The satellite radio service geostationary satellite 190 broadcasts the deactivation command signal periodically. When a satellite radio receiver 136 is powered ON and receives the deactivation command signal, the hardware of the satellite radio receiver 136 is modified to prevent reception of any satellite broadcast signals. In one embodiment, the satellite radio receiver 136 is modified to allow reception of one satellite broadcast signal at a frequency for a preview channel. The preview channel advertises the SDARS, for example.

During stage S204, a termination notification is sent from communication service manager 174 in call center 170 to a telematics unit 120 via a wireless interface connection in response to the termination signal. The wireless interface is between the wireless modem 124 and the wireless system. The wireless system comprises one or more wireless carrier systems 140, one or more communication networks 142, and one or more land networks 144. The processor 122 connected to the wireless modem 124 receives the termination confirmation. The memory 128 connected to the processor 122 has a computer readable medium for storing a computer program to recognize the termination notification and to generate a termination confirmation in response to the termination notification. The processor 122 utilizes software in memory 128 to generate a termination confirmation in response to the termination notification.

During stage S206, the termination confirmation is sent from the telematics unit 170 to the communication service manager 174 in response to the termination notification. The termination confirmation is transmitted via the wireless modem 124 to the wireless system.

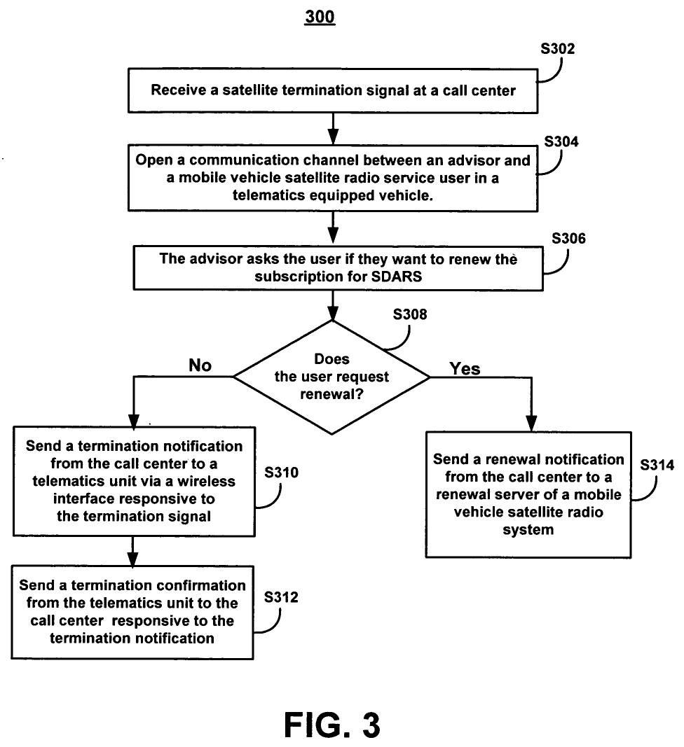

FIG. 3 illustrates a flowchart 300 representative of one embodiment of a method to activate a customer termination confirmation process in accordance with the present invention. During stage S302, the communication service manager 174 receives a satellite termination signal. The satellite termination signal is transmitted to the communication service manager 174 as described for stage S202 in flowchart 200.

During stage S304, the communication service manager 174 opens a communication channel between a communication services advisor 178 and the mobile vehicle satellite radio service user in the telematics equipped vehicle MVCU 110. The communication channel is over the network comprising one or more wireless carrier systems 140, one or more communication networks 142, one or more land networks 144.

During stage S306, the advisor 178 communicates with the user of mobile vehicle 110 and determines if the user will renew the recently deactivated subscription for SDARS. During stage S308, the advisor determines whether the user requested renewal in response to the advisor's question.

If the user requests renewal, the flow proceeds to stage S314. During stage S314, in response to the users renewal request, the advisor 178 sends a renewal notification from the call center 170 to a renewal server of a mobile vehicle satellite radio system. The renewal server is located in the satellite radio service uplink facility 181. The renewal notification is transmitted over one or more wireless carrier systems 140, one or more communication networks 142, one or more land networks 144.

In one embodiment, the user provides a credit card number to pay for the renewal of service. In another embodiment, the user is billed by the mobile vehicle satellite radio system for the renewal of service. In another embodiment, the method of payment is encoded in the renewal notice.

If the user does not request renewal of their subscription to the mobile vehicle satellite radio system, the flow proceeds to stage S310 and a confirmation of deactivation of a mobile vehicle satellite radio service commences according the process described in flowchart 200 of FIG. 2. During stage S310, a termination notification is sent from communication service manager 174 in call center 170 to a telematics unit 120 via a wireless interface in response to the termination signal. Stage 310 is identical to stage S204 described in flowchart 200 of FIG. 2. During stage S312, the termination confirmation is sent from the telematics unit 170 to the communication service manager 174 in call center 170 in response to the termination notification. Stage 312 is identical to stage S206 described in flowchart 200 of FIG. 2.

In one embodiment, the customer termination confirmation processes is initiated by a vehicle data upload trigger from the call center 170 to the telematics unit 120.

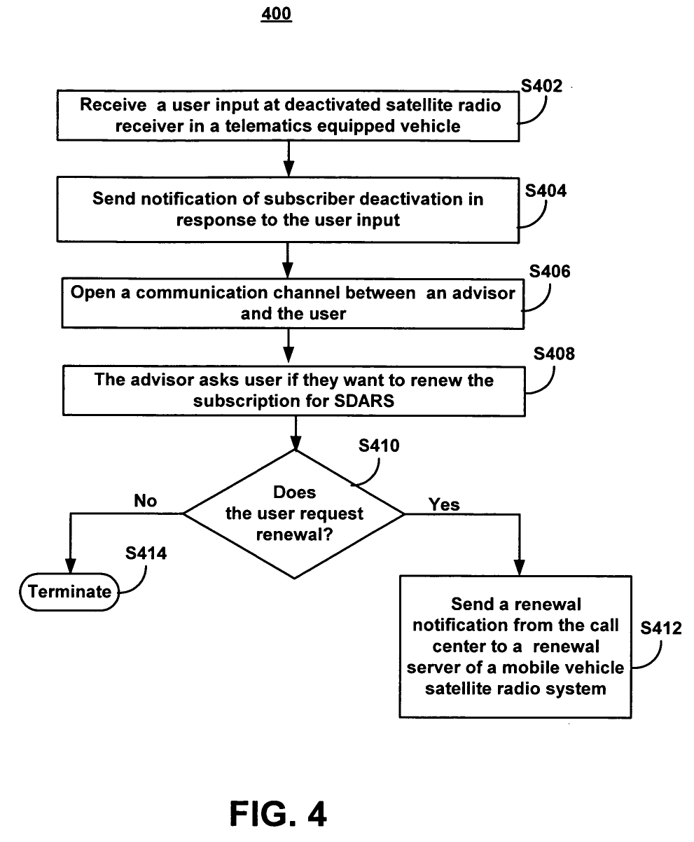

FIG. 4 illustrates a flowchart 400 representative of one embodiment of a method to renew a mobile vehicle satellite ratio service in accordance with the present invention. During stage S402, a user input is received at a deactivated satellite radio receiver 136. When a user attempts to activate the satellite radio receiver 136, such as by pushing a button, the user input is received. Alternatively, the button push may occur if the user does not recall termination of the SDARS. In an alternative embodiment, the button push occurs if the user remembers the service for the mobile vehicle satellite radio system was deactivated but wants to re-subscribe to the service. The processor 122 of telematics unit 120 recognizes that a user input was made on a deactivated satellite radio receiver 136.

During stage S404, a notification of subscriber deactivation is sent to a user of a deactivated satellite radio receiver in response to a user input to the satellite radio receiver. Processor 122 generates the notification of subscriber deactivation after communicating with the memory 128 to confirm the deactivation. The notification of subscriber deactivation is a verbal communication to the user over in-vehicle mobile phone 134 or speakers 132 in the MVCU 110. In another embodiment, a message is displayed on a visual display in the MVCU 110 to notify the user about the deactivation. In another embodiment, the notification of subscriber deactivation is both a message displayed on the display in the MVCU 110 and a verbal communication to the user.

During stage S406, a communication channel is opened between an advisor 178 and the user in the MVCU 110. The communication channel is opened over the wireless system comprising one or more wireless carrier systems 140, one or more communication networks 142, one or more land networks 144. The processor 122 triggers the telematics unit 120 to open a communication channel between an advisor 178 and the user in the MVCU 110 in response to the notification of the subscriber deactivation.

During stage S408, the advisor 178 communicates with the user to determine whether the user wishes to renew the subscription for SDARS. During stage S410, the advisor determines whether the user requested renewal in response to the advisor's question.

If the user requests renewal, the flow proceeds to stage S412. During stage S412, in response to the users renewal request, the advisor 178 sends a renewal notification from the call center 170 to a renewal server of a mobile vehicle satellite radio system. The renewal server is in communication with the satellite radio service uplink facility 181. In one embodiment, the renewal server is located in the satellite radio service uplink facility 181. The renewal notification is transmitted over one or more wireless carrier systems 140, one or more communication networks 142, one or more land networks 144.

In one embodiment, the user provides a credit card number to pay for the renewal of service. In another embodiment, the user is billed by the mobile vehicle satellite radio system for the renewal of service. In one embodiment, the method of payment is encoded in the renewal notice.

If the user does not request renewal of their subscription to the mobile vehicle satellite radio system, the flow proceeds to stage S414. During stage S414, the flow is terminated since the user did not elect to re-subscribe to service with the mobile vehicle satellite radio system. The flow described in flowchart 400 ensures that the user is provided the opportunity to re-subscribe if they try to use the satellite radio receiver 136. The user will not be confused about why the satellite radio receiver 136 does not work.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method for confirming deactivation of a mobile vehicle satellite radio service, the method comprising:
receiving a satellite radio termination signal at a call center;
sending a termination notification from the call center to a telematics unit via a wireless interface responsive to the termination signal; and
sending a termination confirmation from the telematics unit to the call center responsive to the termination notification.

2. The method of claim 1, further comprising:
transmitting a deactivation command from a deactivation server of a mobile vehicle satellite radio system to a satellite radio receiver of a telematics equipped vehicle; and
sending the satellite radio termination signal from the deactivation server to the call center responsive to the transmitting.

3. The method of claim 1, further comprising:
activating a customer termination confirmation process in response to receiving the satellite radio termination signal.

4. The method of claim 3, wherein the customer termination confirmation process is initiated by a vehicle data upload.

5. The method of claim 3, wherein the customer termination confirmation process comprises opening a communication channel between an advisor and a mobile vehicle satellite radio service user in a telematics equipped vehicle.

6. The method of claim 1, further comprising:
sending a notification of subscriber deactivation to a user of a deactivated satellite radio receiver in response to a user input to the satellite radio receiver.

7. The method of claim 1, further comprising:
renewing the mobile vehicle satellite radio service for a user of a deactivated satellite radio receiver in a telematics equipped vehicle.

8. The method of claim 7, wherein renewing the mobile vehicle satellite radio service comprises
sending a renewal notification from the call center to a renewal server of a mobile vehicle satellite radio system in response to a renewal request.

9. A system to confirm deactivation of a mobile vehicle satellite radio service, the system comprising:
means for receiving a satellite radio termination signal at a call center;
means for sending a termination notification from the call center to a telematics unit via a wireless interface responsive to the termination signal; and
means for sending a termination confirmation from the telematics unit to the call center responsive to the termination notification.

10. The system of claim 9, further comprising:
means for activating a customer termination confirmation process in response to receiving the satellite radio termination signal.

11. The system of claim 9, further comprising:
means for sending a notification of subscriber deactivation to a user of a deactivated satellite radio receiver in response to a user input to the satellite radio receiver.

12. The system of claim 9, further comprising:
means for renewing the mobile vehicle satellite radio service for a user of a deactivated satellite radio receiver in a telematics equipped vehicle.

13. A computer readable medium storing a computer program comprising:
computer readable code for receiving a satellite radio termination signal at a call center;
computer readable code for sending a termination notification from the call center to a telematics unit via a wireless interface responsive to the termination signal; and
computer readable code for sending a termination confirmation from the telematics unit to the call center responsive to the termination notification.

14. The medium of claim 13, wherein the satellite radio termination signal is sent from a deactivation server of a mobile vehicle satellite radio system in response to a deactivation command being sent from the deactivation server to a satellite radio receiver of a telematics equipped vehicle.

15. The medium of claim 13, further comprising:
computer readable code for activating a customer termination confirmation process in response to receiving the satellite radio termination signal.

16. The medium of claim 15, wherein the customer termination confirmation process is initiated by a vehicle data upload.

17. The medium of claim 15, wherein the customer the customer termination confirmation process comprises computer readable code for opening a communication channel between an advisor and a mobile vehicle satellite radio service user in a telematics equipped vehicle.

18. The medium of claim 13, further comprising:
computer readable code for sending a notification of subscriber deactivation to a user of a deactivated satellite radio receiver in response to a user input to the satellite radio receiver.

19. The medium of claim 13, comprising:
computer readable code for renewing the mobile vehicle satellite radio service for a user of a deactivated satellite radio receiver in a telematics equipped vehicle.

20. The medium of claim 19, further comprising:
computer readable code for sending a renewal notification from the call center to a renewal server of a mobile vehicle satellite radio system in response to a renewal request.
